(19) United States
(12) Patent Application Publication
(10) Pub. No.: US 2022/0318643 A1
(43) Pub. Date: Oct. 6, 2022

(54) METHOD FOR DETERMINING A PARAMETER, IN PARTICULAR, OF A LUBRICATING METHOD OR OF A LUBRICANT

(71) Applicant: Robert Bosch GmbH, Stuttgart (DE)

(72) Inventors: Dominic Lingenfelser, Hambruecken (DE); Elisabeth Lotter, Pforzheim (DE)

(21) Appl. No.: 17/596,029

(22) PCT Filed: Aug. 14, 2020
(86) PCT No.: PCT/EP2020/072851

§ 371 Date: Dec. 2, 2021

(30) Foreign Application Priority Data
Aug. 19, 2019 (DE) 10 2019 212 336.8

(51) Int. Cl. G06N 5/02

(52) U.S. Cl. CPC G06N 5/022

(57) ABSTRACT

A device and method for determining a parameter of a lubricating method or of a lubricant. At least one input variable for a model is provided. The parameter is determined as a function of the model. The model encompasses a module which determines the parameter as a function of the at least one input variable. The model is trained as a function of input data which encompass data sets of the at least one input variable and an assignment of each of the data sets to a setpoint parameter. As a function of a comparison of a parameter determined for one of the data sets to the setpoint parameter assigned to this data set, either the model is continued to be trained, or a modified model is determined and the modified model being trained.

### FIELD

The present invention relates to a device and to a method for determining a parameter, in particular, of a lubricating method or of a lubricant.

### BACKGROUND INFORMATION

At present, the examination of process or material properties in this regard necessitates various, partial time- and cost-intensive measurements, making an immediate decision about the state of the material and of the process impossible.

### SUMMARY

In accordance with an example embodiment of the present invention, a method and a device are provided, by which process and/or material data may be detected almost in real time. As a result, processes may be directly optimized. This makes it possible both to ensure consistent product quality and to save costs for the material. The present invention makes it possible to detect product deviations due to unconscious manipulation, e.g., batch fluctuations, or conscious manipulations or changes, e.g., product counterfeits, at an early stage in a simple, precise and inexpensive manner. Furthermore, by intelligently linking the predicted material parameters and existing process parameters, reliable and robust process windows may be established for optimal product quality.

In accordance with an example embodiment of the present invention, a method for determining a parameter, in particular, of a lubricating method or of a lubricant, provides that at least one input variable is provided for a model, and the parameter is determined as a function of the model, the model encompassing a module which is designed to determine the parameter as a function of the at least one input variable, the model being trained as a function of input data which encompass data sets of the at least one input variable and an assignment of each of the data sets to a setpoint parameter, as a function of a comparison of a parameter determined for one of the data sets to the setpoint parameter assigned to this data set either the model being further trained, or a modified model being determined by adding a module to the model and/or by removing from the model at least one module which differs from the module for determining the parameter, and the modified model being trained. In this way, process or material parameters may be predicted from indirect measurements, where the information would not be accessible without the use of artificial intelligence.

Preferably, at least one of the input variables characterizes machine data, in particular, a profile of an oil temperature (oil temperature [C]), an oil pressure (pLoad [bar]), an oil pressure upstream from a valve (p_upstream from_Y1 [bar]), an oil pressure downstream from the valve (p_downstream from_Y1 [bar]), a pressure of a cooling water (p_coolingwater [bar]), a torque of the machine (torque [Nm]), a power of the machine (power), a pressure upstream from an oil filter (p_upstream from oil filter [bar]), a pressure downstream from an oil filter (p downstream from oil filter [bar]) a temperature of the oil downstream from a cooler (temp downstream from cooler [C]), or a leakage oil temperature (leakage oil temp [C]) against the time.

The parameter preferably characterizes a chemical composition of oil, a material property of oil, a machine parameter based on oil or a process parameter based on oil, in particular, a viscosity of oil. In particular, the following aspects are suitable for the lubricant: Category 1: chemical composition such as base oil, additives, impurities. Category 2: material property such as water content, additive concentration, flowability, viscosity of the material (viscosity number), lubricity, content of fatty acid methyl ester, cetane number, density, proportion of polycyclic aromatic hydrocarbons, flash point, proportion of fatty acid methyl esters (FAME), element content, sulfur content, phosphorus content, acid number, base number (TAN, TBN), methanol content, electrical conductivity, particle content. Category 3: machine parameters or a process parameter such as deviations from setpoint and actual values.

The module is preferably designed to learn a decision tree for a classification and/or a regression, which maps the at least one input variable to the parameter and/or the module being designed to determine the parameter as a function of the decision tree. This method is particularly suitable for modeling. In particular, partial least squares regression (PLS reg), partial least squares classification (PLS DA), linear discriminant analysis (LDA), ridge regression, multiple linear regression (MLR), logistic regression, a random forest, a support vector machine (SVM) or an artificial neural network (ANN) may be used for determining the parameter.

The parameter is preferably determined as a function of a combination of input variables, as a function of the comparison either one module being further used for a model input having this combination of input variables or another module being used for a model input having a different combination of input variables for the modified model. For example, the following combination is suitable for machine data of a machine which generates a torque and includes an oil filter and in which oil is cooled in a cooler with the aid of cooling water, for the regression of a viscosity: oil temperature, power of the machine, pressure upstream from oil filter, pressure downstream from oil filter, torque of the machine, pressure of the cooling water, temperature of the oil downstream from the cooler, and leakage oil temperature.

Preferably, it is provided that the at least one module is designed to preprocess the at least one input variable, in particular using detrending, derivation, mean centering, Savitzky-Golay filtering, Fourier transform, or standard normal variate (SNV). This data preprocessing is adaptable to the particular input data.

Preferably, it is provided that the at least one module is designed to eliminate disturbance variables from the at least one input variable, in particular, using error removal by orthogonal subtraction (EROS), external parameter orthogonalization (EPO), wavelet transform or Fourier transform. This enables an independence with respect to the devices of the process or the sensors used for detecting the input variables.

Preferably, it is provided that the at least one module is designed for dimension reduction or feature selection, in particular using principal component analysis (PCA), for dimension reduction, stepwise variable selection (SVS) or Procrustes variable selection. In this way, the computational speed of the model is increased.

Preferably, at least one of the input variables characterizes spectral data, in particular UV Vis, near infrared (NIR), mid-infrared (FTIR), far infrared, terahertz, Raman, chemiluminescence, or X-ray fluorescence analysis (XRF). Spectral data in the range of 300 nm to 3 mm wavelength are particularly suitable.

Preferably, at least one of the input variables characterizes a chromatographic method, in particular gas chromatography (GC) or liquid chromatography (LC).

The parameter is preferably determined as a function of a certain input variable, as a function of the comparison either one module being further used for a model input having this certain input variable or another module being used for a model input having a different combination of input variables for the modified model. The model thus learns the modules to be expediently used independently or through user selection.

Preferably, at least one process parameter and/or at least one material property is/are identified as a function of at least one parameter, and thus a deviation from a setpoint value therefor is recognized or a setpoint value for a process window is established. A lubricating process or a process for manufacturing a lubricant is thus automatically influenceable.

In accordance with an example embodiment of the present invention, a device for determining a parameter, in particular of a lubricating method or of a lubricant, provides that the device includes a plurality of processors and at least one memory for a model, which are designed to carry out the method.

Further advantageous specific embodiments of the present invention are derived from the following description and the figures.

### BRIEF DESCRIPTION OF THE DRAWINGS

FIG. 1 shows a device for determining a parameter, in accordance with an example embodiment of the present invention.

FIG. 2 shows a method for determining the parameter, in accordance with an example embodiment of the present invention.

FIG. 3 shows machine data for determining the parameter, in accordance with an example embodiment of the present invention.

FIG. 4 shows a regression model for determining the parameter, in accordance with an example embodiment of the present invention.

### DETAILED DESCRIPTION OF EXAMPLE EMBODIMENT

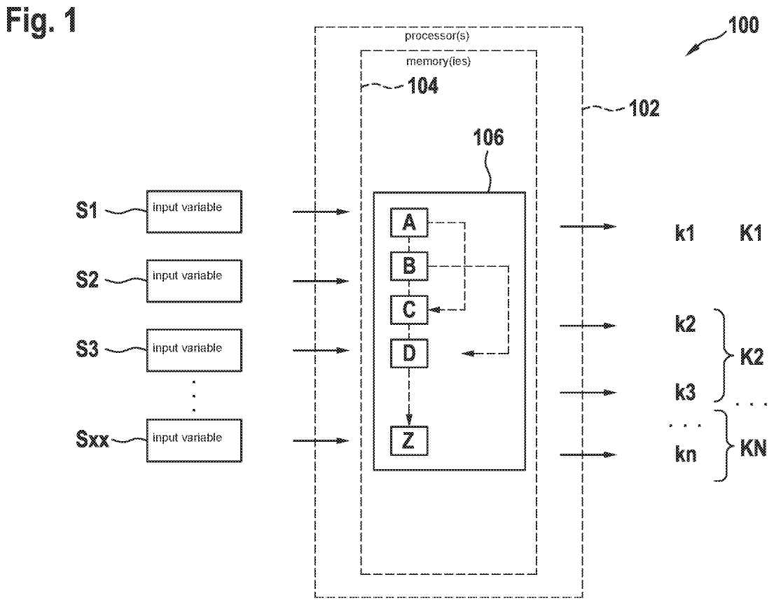

FIG. 1 schematically shows a device 100 for determining a parameter, in particular, of a lubricating method or of a lubricant. The example provides for the determination of a plurality of parameters k1, k2, . . . , kn from different categories K1, K2, . . . , KN. Device 100 includes a plurality of processors 102 and a memory 104 for a model 106. Device 100 is designed to carry out the method described hereafter. In particular, a powerful processor may be provided for a training of model 106, which is designed to determine parameters of model 106.

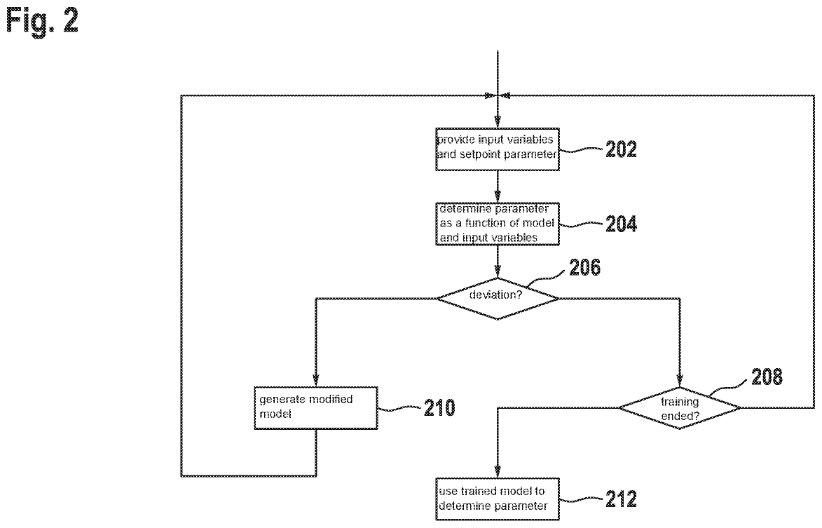

The method described hereafter based on FIG. 2 is used to determine a parameter, or multiple parameters, of a lubricating method or of a lubricant. Hereafter, initially the determination of a parameter proceeding from input variables S1, . . . , Sxx is described. The parameter may be a chemical composition, a material property, a machine parameter or a process parameter.

At least one of input variables S1, . . . , Sxx may characterize spectral data. The spectral data may, in particular, be based on UV Vis, near infrared (NIR), mid-infrared (FTIR), far infrared, terahertz, Raman, chemiluminescence, or X-ray fluorescence analysis (XRF).

At least one of input variables S1, . . . , Sxx may characterize a chromatographic method. The chromatographic methods are, in particular, gas chromatography (GC) or liquid chromatography (LC).

At least one of input variables S1, . . . , Sxx may characterize machine data. The machine data are, in particular, an oil temperature, a power, a pressure upstream from an oil filter, a pressure downstream from an oil filter, a torque, a pressure of cooling water, or a temperature downstream from a cooler.

At least one of input variables S1, . . . , Sxx may be a variable detected by a sensor. Providing the at least one input variable S1, . . . , Sxx means that the at least one input variable S1, . . . , Sxx encompasses sensor data representing the input variables of model 106 or of its modules.

In a training phase, it is provided to train model 106 as a function of input data which encompass data sets of input variables S1, . . . , Sxx and an assignment of each of the data sets to a setpoint parameter. Model 106 includes at least one module D, which is designed to determine the parameter as a function of input variable S1, . . . , Sxx. Module D may be designed for classification and/or regression. Module D may, in particular, encompass an algorithm for partial least squares regression/classification (PLS reg, PLS DA), linear discriminant analysis (LDA), ridge regression, multiple linear regression (MLR), logistic regression, decision and regression tree, a random forest, a support vector machine (SVM) or an artificial neural network (ANN).

In a step 202, a plurality of input variables S1, . . . , Sxx is provided for model 106 and a setpoint parameter. Input variables S1, . . . , Sxx and setpoint parameter are provided during training from the training data.

In a subsequent step 204, the parameter is determined as a function of model 106 and as a function of the plurality of input variables S1, . . . , Sxx.

In a step 206, a deviation of this parameter from the setpoint parameter is determined in a comparison of a parameter determined for one of the data sets and the setpoint parameter assigned to this data set. When a deviation from the setpoint parameter drops below a predefined deviation, a step 208 is carried out. Otherwise, a step 210 is carried out.

In step 208, it is checked whether the training has ended. If the training has ended, a step 212 is carried out. Otherwise, step 202 is carried out. When step 202 is carried out again, the same module 106 is continued to be trained.

In step 212, model 106 thus trained is used for determining the parameter as a function of at least one of input variables S1, . . . , Sxx. For example, the parameter for a plastic process or for a plastic material is determined. For example, at least one process parameter and/or at least one material property is/are identified as a function of at least one parameter, and thus a deviation from a setpoint value therefor is recognized or a setpoint value for a process window is established.

In step 210, a modified model is generated. The modified model may be generated by adding a further module A, B, C, E, . . . , Z to the model. The modified model may be determined by removing from model 106 at least one module A, B, C, E, . . . , Z differing from module D for determining the parameter.

At least one module A may be provided, which is designed to preprocess the at least one input variable S1, . . . , Sxx, in particular, using detrending, derivation, mean centering, Savitzky-Golay filtering, Fourier transform, or standard normal variate (SNV).

At least one module B may be provided, which is designed to eliminate disturbance variables from the at least one input variable S1, . . . , Sxx, in particular using error removal by orthogonal subtraction (EROS), external parameter orthogonalization (EPO), wavelet transform or Fourier transform.

At least one module C may be provided, which is designed for dimension reduction or feature selection, in particular using principal component analysis (PCA), for dimension reduction, stepwise variable selection (SVS) or Procrustes variable selection.

Thereafter, step 202 is carried out for the modified module. With this, the modified model is trained.

It may be provided that the parameter is determined as a function of a combination of input variables S1, . . . , Sxx.

For example, the following combination is suitable for machine data of a machine which generates a torque and includes an oil filter and in which oil is cooled in a cooler with the aid of cooling water, for the regression of a viscosity: oil temperature, power of the machine, pressure upstream from oil filter, pressure downstream from oil filter, torque of the machine, pressure of the cooling water, temperature of the oil downstream from the cooler, and leakage oil temperature.

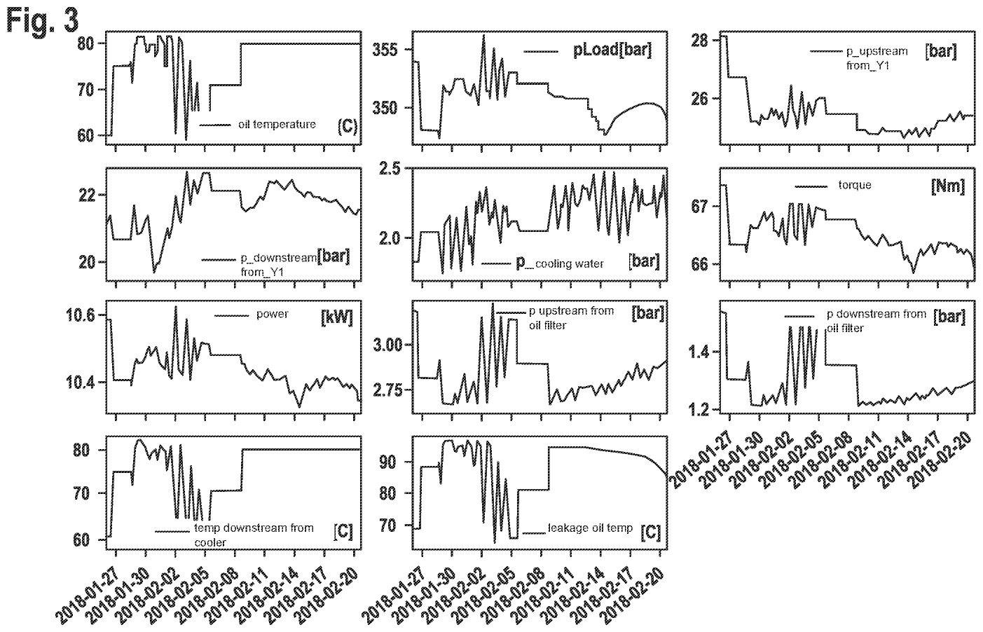

FIG. 3 represents an exemplary data set for these machine data for the determination of the parameter. From the top left to the bottom right, profiles are shown for an oil temperature: oil temperature [C], oil pressure: pLoad [bar], oil pressure upstream from valve: p_upstream from_Y1 [bar], oil pressure downstream from valve: p_downstream from_Y1 [bar], pressure of the cooling water: p_coolingwater [bar], torque of the machine: torque [Nm], power of the machine: power [kW], pressure upstream from oil filter: p_upstream from oil filter [bar], pressure downstream from oil filter: p downstream from oil filter [bar], temperature of the oil downstream from the cooler: temp downstream from cooler [C], and leakage oil temperature: leakage oil temp [C]) against the time.

In the example, a random forest or a support vector machine are provided for this purpose. In the example described hereafter, module D encompasses at least one decision tree. This decision tree grows during the training. The model thus trained encompasses the decision tree or may encompass a random forest, including a plurality of decision trees. In this example, the model is used for regression.

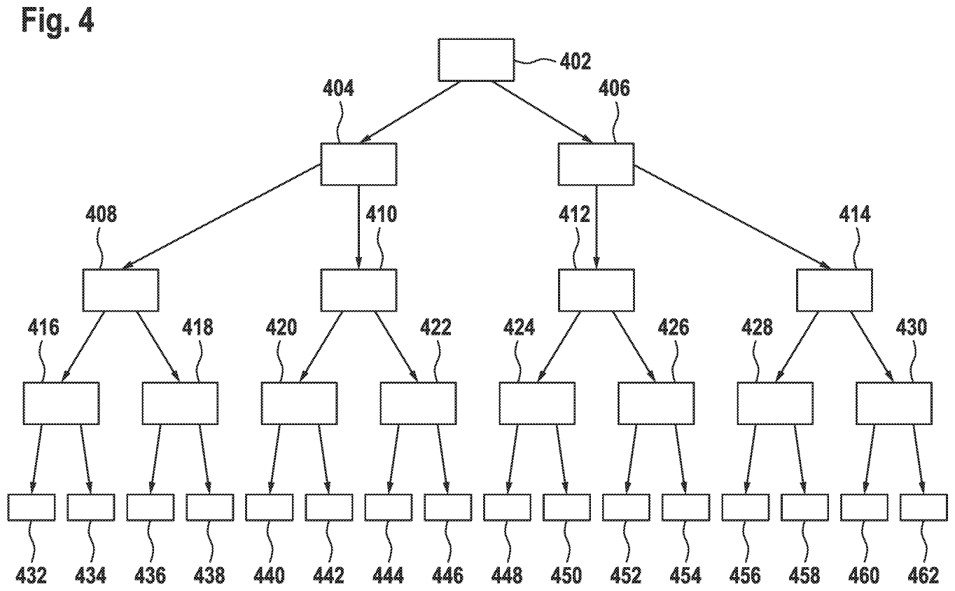

FIG. 4 schematically shows a regression model which is based on the machine data from FIG. 3 for the determination of the parameter. Decision tree 400 shown in FIG. 4 encompasses root node 402, inner nodes 404 through 430, and leaves 432 through 462. In the process, the nodes represent logic rules, and the leaves represent a respective parameter. The logic rules are indicated hereafter for root node 402 and inner nodes 404 through 430. If the logic rule of a node applies, this is denoted hereafter by ‘True.’ If the logic rule of a node does not apply, this is denoted hereafter by ‘False.’ A subsequent node or a subsequent leaf is denoted hereafter by an indication of a reference numeral.

Root Node 402
p_downstream from_Y1 [bar]≤19.0062
mse=10.9849
samples=14100
value=16.1277
True: 404
False: 406

Node 404
Leakage oil temp [C]≤92.9372
mse=2.4079
samples=5309
value=19.9284
True: 408
False: 410

Node 406
pLoad [bar]≤350.4665
mse=1.737
samples=8691
value=13.7622
True: 412
False: 414

Node 408
Leakage oil temp [C]<=91.9529
mse=0.6347
samples=3674
value=20.8005
True: 416
False: 418

Node 410
Torque [Nm]≤65.6086
mse=1.142
samples=1735
value=18.0817
True: 420
False: 422

Node 412

Leakage oil temp [C]≤92.1152
mse=0.3069
samples=5584
value=14.4825
True: 424
False: 426

Node 414
p_upstream from_Y1 [bar]≤24.916
mse=1.6988
samples=3107
value=12.4677
True: 428
False: 430

Node 416
Leakage oil temp [C]<=91.2191
mse=0.0938
samples=1066
value=21.7656
True: 432
False: 434

Node 418
p_upstream from_Y1 [bar]≤24.8339
mse=0.3195
samples=2608
value=20.406
True: 436
False: 438

Node 420
Leakage oil temp [C]<=93.4714
mse=0.3752
samples=1287
value=18.6203
True: 440
False: 442

Node 422
Leakage oil temp [C]<=93.6736
mse=0.1171
samples=448
value=16.5344
True: 444
False: 446

Node 424
Leakage oil temp [C]<=88.5994
mse=0.0779
samples=2115
value=14.9519
True: 448
False: 450

Node 426
p_downstream from_Y1 [bar]≤22.1458
mse=0.2303
samples=3469
value=14.1963
True: 452
False: 454

Node 428
Leakage oil temp [C]<=94.2829
mse=0.2944
samples=1837
value=11.462
True: 456
False: 458

Node 430
Leakage oil temp [C]<=94.7422
mse=0.1511
samples=1270
value=13.9224
True: 460
False: 462

Leaf 432
mse=0.0092
samples=646
value=22.0034

Leaf 434
mse=0.0031
samples=420
value=21.3997

Leaf 436
mse=0.1534
samples=1100
value=20.8827

Leaf 438
mse=0.1541
samples=1508
value=20.0583

Leaf 440
mse=0.0804
samples=818
value=19.0173

Leaf 442
mse=0.1353
samples=469
value=17.9281

Leaf 444
mse=0.0525
samples=196
value=16.8556

Leaf 446
mse=0.0246
samples=252
value=16.2845

Leaf 448
mse=0.0044
samples=543
value=15.375

Leaf 450
mse=0.0201
samples=1572
value=14.8058

Leaf 452
mse=0.0963
samples=3314
value=14.2763

Leaf 454
mse=0.0318
samples=155
value=12.4857

Leaf 456
mse=0.1507
samples=879
value=11.9158

Leaf 458
mse=0.0637
samples=958
value=11.0455

Leaf 460
mse=0.1714
samples=936
value=14.0147

Leaf 462
mse=0.0032
samples=334
value=13.6636

It may be provided that, as a function of the comparison, either one module is continued to be used for a model input having this combination of input variables S1, . . . , Sxx or another module is used for a model input having a different combination of input variables S1, . . . , Sxx for the modified model.

It may be provided that the parameter is determined as a function of a certain input variable S1, . . . , Sxx, as a function of the comparison either one module being continued to be used for a model input having this particular input variable S1, . . . , Sxx or another module being used for a model input having a different combination of input variables S1, . . . , Sxx for the modified model.

In addition, a further module Z may be provided, which includes an, in particular, configurable further function for the processing of input variable S1, . . . , Sxx.

Trained module 106 may also be used after the training, independently of training steps 202 through 210.

1-15. (canceled)

16. A method for determining a parameter of a lubricating method or of a lubricant, the method comprising the following steps:
providing at least one input variable for a model; and
determining the parameter as a function of the model, the model including a module which is configured to determine the parameter as a function of the at least one input variable, the model being trained as a function of input data which encompass data sets of the at least one input variable and an assignment of each of the data sets to a respective setpoint parameter, wherein as a function of a comparison of a parameter determined for one of the data sets to the respective setpoint parameter assigned to the one of the data sets, either: (i) the model is continued to be trained, or (ii) a modified model is determined by adding a module to the model and/or by removing from the model at least one module which differs from the module for determining the parameter, and the modified model is trained.

17. The method as recited in claim 16, wherein at least one of the input variables characterizes machine data, or a profile of an oil temperature, or an oil pressure, or an oil pressure upstream from a valve, or an oil pressure downstream from the valve, or a pressure of a cooling water, or a torque of the machine, or a power of the machine, or a pressure upstream from an oil filter, or a pressure downstream from an oil filter, or a temperature of the oil downstream from a cooler, or a leakage oil temperature against time.

18. The method as recited in claim 16, wherein the parameter characterizes a chemical composition of oil, or a material property of oil, or a machine parameter based on oil, or a process parameter based on oil, or a viscosity of oil.

19. The method as recited in claim 16, wherein the module is configured to learn a decision tree for a classification and/or a regression, which maps the at least one input variable to the parameter and/or the module is configured to determine the parameter as a function of the decision tree.

20. The method as recited in claim 16, wherein the parameter is determined as a function of a combination of the input variables, and, as a function of the comparison, either (i) the module is continued to be used for a model input having the combination of input variables, or (ii) another module being used for a model input having a different combination of the input variables for the modified model.

21. The method as recited in claim 16, wherein the module is configured to preprocess the at least one input variable, using detrending, or derivation, or mean centering, or Savitzky-Golay filtering, or Fourier transform, or standard normal variate (SNV).

22. The method as recited in claim 16, wherein the module is configured to eliminate disturbance variables from the at least one input variable, including using error removal by orthogonal subtraction or external parameter orthogonalization (EPO) or wavelet transform or Fourier transform.

23. The method as recited in claim 16, wherein the module is configured for dimension reduction or feature selection, using principal component analysis, for dimension reduction or stepwise variable selection or Procrustes variable selection.

24. The method as recited in claim 16, wherein at least one of the input variables characterizes spectral data, the spectral data being UV Vis, near infrared, or mid-infrared, or far infrared, or terahertz, or Raman, or chemiluminescence, or X-ray fluorescence analysis.

25. The method as recited in claim 16, wherein at least one of the input variables characterizes a chromatographic method, the chromatographic method being gas chromatography or liquid chromatography.

26. The method as recited in claim 16, wherein the parameter is determined as a function of a certain input variable of the input variables, and, as a function of the comparison, either: (i) the module is continued to be used for a model input having the certain input variable, or (ii) another module is used for a model input having a different combination of input variables for the modified model.

27. The method as recited in claim 16, wherein at least one process parameter and/or at least one material property is identified as a function of the parameter, and a deviation from a setpoint value is recognized or a setpoint value for a process window is established.

28. A device for determining a parameter of a lubricating method or of a lubricant, the device comprising:
a plurality of processors; and
at least one memory for a model;
wherein the device is configured to
provide at least one input variable for the model, and
determine the parameter as a function of the model, the model including a module which is configured to determine the parameter as a function of the at least one input variable, the model being trained as a function of input data which encompass data sets of the at least one input variable and an assignment of each of the data sets to a respective setpoint parameter, wherein as a function of a comparison of a parameter determined for one of the data sets to the respective setpoint parameter assigned to the one of the data sets, either: (i) the model is continued to be trained, or (ii) a modified model is determined by adding a module to the model and/or by removing from the model at least one module which differs from the module for determining the parameter, and the modified model is trained.

29. A non-transitory machine-readable memory medium on which is stored a computer program for determining a parameter of a lubricating method or of a lubricant, the computer program, when executed by a computer, causing the computer to perform the following steps:
providing at least one input variable for a model; and
determining the parameter as a function of the model, the model including a module which is configured to determine the parameter as a function of the at least one input variable, the model being trained as a function of input data which encompass data sets of the at least one input variable and an assignment of each of the data sets to a respective setpoint parameter, wherein as a function of a comparison of a parameter determined for one of the data sets to the respective setpoint parameter assigned to the one of the data sets, either: (i) the model is continued to be trained, or (ii) a modified model is determined by adding a module to the model and/or by removing from the model at least one module which differs from the module for determining the parameter, and the modified model is trained.
